(19) United States
(12) Patent Application Publication
(10) Pub. No.: US 2007/0071527 A1
(43) Pub. Date: Mar. 29, 2007

(54) Auto Document Feeder, Document Feeding Method And Computer Usable Medium

(75) Inventor: Nobuhiko Suzuki, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/536,627

(22) Filed: Sep. 28, 2006

(30) Foreign Application Priority Data
Sep. 29, 2005 (JP) 2005-284113

(51) Int. Cl. G03G 15/00

(52) U.S. Cl. 399/367

(57) ABSTRACT

An auto document feeder that includes: a document delivering unit that delivers a document along a document delivery path including a reading position; a switchback delivering unit that returns the document from a downstream side of the reading position to an upstream side of the reading position with a leading end and a trailing end of the document inverted through a switchback delivery path coupled to a predetermined position of the document delivery path; and a control unit that drives the document delivering unit at a reading speed corresponding to a reading resolution when delivering the document on the reading position and drives the document delivering unit and the switchback delivering unit at a delivery speed that is higher than the reading speed when returning the document to the reading position through the switchback delivery path.

### CROSS REFERENCE TO RELATED APPLICATION

This application claims priority from Japanese Patent Application No. 2005-284113, filed on Sep. 29, 2005, the entire subject matter of which is incorporated herein by reference.

### TECHNICAL FIELD

Aspects of the present invention relate to an auto document feeder comprising a document delivering unit for delivering a document along a document delivery path that couples a document mounting portion and a document discharging portion via a reading position and a switchback delivering unit for returning the document from a downstream side of the reading position to an upstream side of the reading position with a leading and a trailing end inverted through a switchback delivery path coupled to a predetermined position of the document delivery path.

### BACKGROUND

Conventionally, there has been known an image reading apparatus which is to be mounted on a copying apparatus, a scanner apparatus or a multi function apparatus having a copy function and a scanner function and comprises an auto document feeder referred to as an ADF for delivering a document from a paper feed tray to a paper discharge tray through a delivery path. Moreover, there has been known an auto document feeder for switching back a document, which has both sides (first and second faces) that are printed, in the middle of a delivery to invert a leading and a trailing end in the document, thereby carrying out a delivery for reading both sides of the document in order to read the document (for example, see Japanese Patent No. 3546822).

FIG. 16 shows a delivery path for a conventional auto document feeder capable of reading both sides. As shown in FIG. 16, a document P having a first face (a first page) mounted upward in a paper feed tray 100 is fed to a delivery path 102 by means of a paper feed roller 101. In the delivery path 102, the document P is delivered to a delivery roller 103 provided properly and the first face of the document P is read by an image reading unit such as a CCD or a CIS when passing through a reading position X. When a sensor detects a trailing end of the document P having the first face read, a paper discharge roller 104 is stopped in such a state as to nip the vicinity of the trailing end of the document.

As shown in FIG. 17, when the paper discharge roller 104 is rotated reversely, the document P is delivered to a switchback path 105. The document P advances to an upstream side of the reading position X of the delivery path 102 from the switchback path 105 again. Consequently, the leading and the trailing end of the document P are inverted. When the document P is delivered by means of the delivery roller 103 and passes through the reading position X, a second face of the document P is read by the image reading unit. When the sensor detects the trailing end of the document P having the second face read, the paper discharge roller 104 is stopped in such a state as to nip the vicinity of the trailing end of the document P again and the document P is then fed reversely through the switchback path 105. The document P advancing to the delivery path 102 from the switchback path 105 again is brought into a state in which the leading and the trailing end are inverted again, that is, a state in which the first face is opposed to the reading position X. Thereafter, the document P is delivered through the delivery path 102 and the first face is turned downward so that the document P is discharged to a paper discharge tray 106. Consequently, both the first and second faces of the document P are read, and furthermore, the document P is discharged to the paper discharge tray 106 in loading order onto the paper feed tray 100.

In a double side reading operation, thus, the document is delivered to pass through the reading position X three times. Therefore, it is necessary to take at least a double of a delivery time for a single side reading operation in which the document is caused to pass through the reading position X only once. For example, in a copying apparatus comprising an ADF, a so-called loss time in which the delivery time in the image reading operation is increased when a time required for recording a read image is reduced becomes obvious as a factor for preventing an increase in a speed of copy.

For such a problem, there has been proposed to carry out a switchback delivery for a previous document in parallel during the delivery of the document from which an image is being read (see JP-A-7-109060). According to the proposal, a next document is fed to the reading position to read the image of the first face when the previous document over which the image reading operation for the first face has been ended is to be switchback delivered, and the previous document is fed to the reading position to read the image of the second face when the next document is to be switchback delivered, and furthermore, a succeeding document is started to be fed. Consequently, the operation for reading the image of the first face of the document fed from the paper feed tray and the operation for reading the image of the second face of the previous document which is switchback delivered are alternately carried out continuously. Therefore, a delivery time for reading both sides of all of the documents is shortened.

### SUMMARY

Aspects of the invention provide an auto document feeder capable of carrying out a delivery for reading both sides of the document and capable of shortening a time required for delivering a document simply and inexpensively irrespective of a reading resolution.

### BRIEF DESCRIPTION OF THE DRAWINGS

FIG. 1 is a perspective view showing a structure of an outer appearance of an image reading apparatus according to an aspect of the invention;

FIG. 2 is a longitudinal sectional view showing an internal structure of the image reading apparatus;

FIG. 3 is an enlarged view showing a structure of a crossing position;

FIG. 4 is an enlarged view showing a structure of a coupling position;

FIG. 5 is an enlarged view showing a structure of a first front sensor;

FIG. 6 is a block diagram showing a structure of a control portion;

FIG. 7 is a timing chart showing a double side reading mode;

FIG. 8 is a schematic view showing an image reading operation in the double side reading mode;

FIG. 9 is a schematic view showing the image reading operation in the double side reading mode;

FIG. 10 is a schematic view showing the image reading operation in the double side reading mode;

FIG. 11 is a schematic view showing the image reading operation in the double side reading mode;

FIG. 12 is a schematic view showing the image reading operation in the double side reading mode;

FIG. 13 is a schematic view showing the image reading operation in the double side reading mode;

FIG. 14 is a schematic view showing the image reading operation in the double side reading mode;

FIG. 15 is a schematic view showing the image reading operation in the double side reading mode;

FIG. 16 is a schematic view showing a document delivery for the double side reading operation by a conventional automatic document delivering apparatus; and

FIG. 17 is a schematic view showing the document delivery for the double side reading operation by the conventional automatic document delivering apparatus.

### DETAILED DESCRIPTION

An aspect of the invention will be described below with reference to the drawings. It is apparent that the aspect is simply a example of the invention and can be properly changed without departing from the scope of the invention.

According to an aspect of the invention, there is provided an auto document feeder comprising: a document delivering unit that delivers a document along a document delivery path by which a document mounting portion and a document discharging portion are connected via a reading position; a switchback delivering unit that returns the document from a downstream side of the reading position to an upstream side of the reading position with a leading end and a trailing end of the document inverted through a switchback delivery path coupled to a predetermined position of the document delivery path; and a control unit that drives the document delivering unit at a reading speed corresponding to a reading resolution when delivering the document on the reading position and drives the document delivering unit and the switchback delivering unit at a delivery speed that is higher than the reading speed when delivering, the document having a first face thereof opposed to the reading position and pulled into the switchback delivery path to the reading position again through the switchback delivery path.

A document over which a double side image reading operation is to be carried out is mounted on the document mounting portion. When the double side image reading operation is started, the documents in the document mounting portion are fed one by one to the document delivery path by the document delivering unit, and the document is fed through the document delivery path so that the first face (surface) is opposed to the reading position. The control unit drives the document delivering unit at a reading speed corresponding to a reading resolution when the leading of the document reaches the reading position. Accordingly, the document passes through the reading position at the reading speed. The document passing through the reading position is guided to the switchback delivery path. The control unit delivers the document having the first face opposed to the reading position and then pulls the document from the downstream side of the reading position into the switchback delivery path, thereby returning the document to the upstream side of the reading position in the document delivery path with the leading end and the trailing end inverted. The control unit drives the document delivering unit and the switchback delivering unit at the delivery speed that is higher than the reading speed when pulling the document into the switchback delivery path and then returning the document from the switchback delivery path to the reading position. The document returned to the document delivery path is delivered so that a second face (back face) is opposed to the reading position. The control unit drives the document delivering unit at a reading speed corresponding to a reading resolution when the leading of the document reaches the reading position. Accordingly, the document passes through the reading position at the reading speed. The document subjected to the double side image reading operation is discharged to the document discharging portion.

According to the auto document feeder, the delivery speed during the operation for delivering the document having the first face opposed to the reading position and pulled into the switchback delivery path to the document delivery path again is higher than a delivering speed (reading speed) during delivering the document on the reading position. Therefore, it is possible to shorten the delivery time required for carrying out the double side image reading operation. In particular, there is an advantage that the delivery time from the end of the image reading operation for the first face to the start of the image reading operation for the second face can be shortened in the case in which the document passing through the reading position is delivered at a reading speed corresponding to a high resolution.

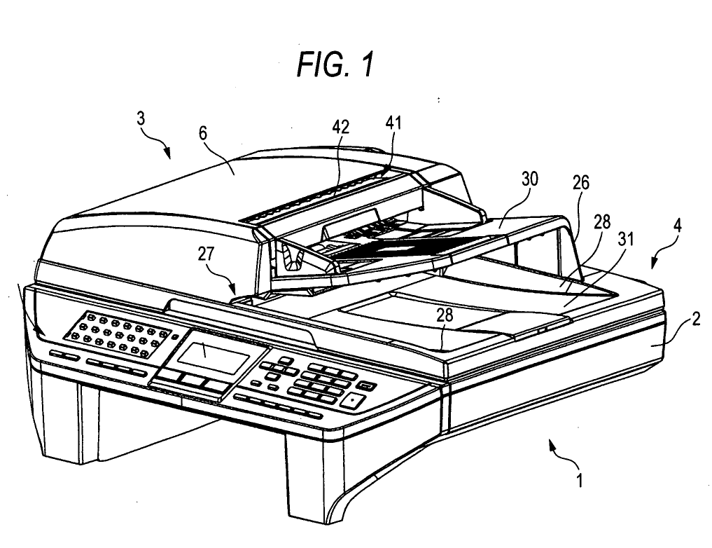

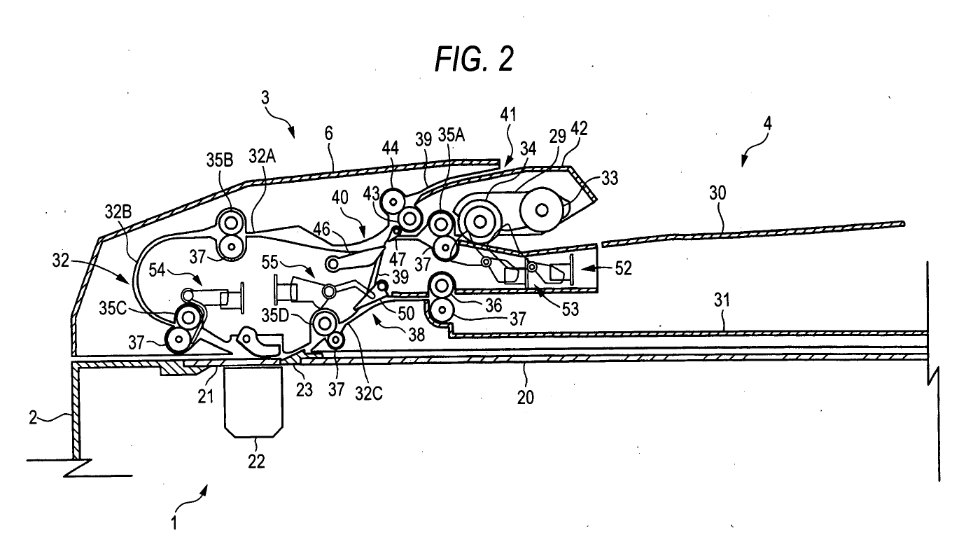

FIGS. 1 and 2 show a main structure of an image reading apparatus 1 according to the aspect of the invention. The image reading apparatus 1 is implemented as an image reading portion for reading an image of a document in a copying apparatus, a facsimile apparatus, a scanner apparatus, and a multi function device (MFD) having a copy function, a facsimile function and a scanner function integrally, for example.

As shown in FIGS. 1 and 2, in the image reading apparatus 1, a document cover 4 including an auto document feeder (ADF) 3 as an automatic document delivery mechanism is attached openably to a document mounting table 2 functioning as an FBS (Flatbed Scanner) through a hinge on a rear side (behind a paper). The ADF 3 constitutes an auto document feeder according to an aspect of the invention.

As shown in FIG. 2, the document mounting table 2 is provided with platen glasses 20 and 21 on a top face opposed to the document cover 4. When the document cover 4 is opened, the platen glasses 20 and 21 are exposed as upper surfaces of the document mounting table 2. When the document cover 4 is closed, the whole upper surface of the document mounting table 2 including the platen glasses 20 and 21 is covered. An image reading unit 22 is provided in the document mounting table 2 opposite to the platen glasses 20 and 21.

The platen glass 20 serves to mount a document when the image reading apparatus 1 is used as the FBS and is formed by a transparent glass plate, for example. An opening for exposing the platen glass 20 is formed on a center of the upper surface of the document mounting table 2. A region of the platen glass 20 exposed from the opening serves as a document reading region in the FBS.

The platen glass 21 is placed in a reading position in the case in which the ADF 3 of the image reading apparatus 1 is used and is formed by a transparent glass plate, for example. An opening for exposing the platen glass 21 is formed in the reading position of the document mounting table 2. The platen glass 21 exposed from the opening is extended in a rear direction of the image reading apparatus 1 corresponding to a length in a main scanning direction of the image reading unit 22.

A positioning member 23 is provided between the platen glass 20 and the platen glass 21. The positioning member 23 is a long plate-shaped member extended in the rear direction of the image reading apparatus 1 in the same manner as the platen glass 21. The positioning member 23 is used as a positioning reference for a document when the document is to be mounted on the platen glass 20 as a document mounting surface in the FBS. For this reason, a central position and positions of both ends of various document sizes such as an A4 size and a B5 size are displayed on the upper surface of the positioning member 23. The upper surface of the positioning member 23 is provided with a guide surface for deflecting the document passing over the platen glass 21 by the ADF 3 to be scooped and returning the document to the ADF 3.

The image reading unit 22 is a so-called image sensor for irradiating a light on the document through the platen glasses 20 and 21 from a light source and collecting the light reflected from the document into a light receiving unit through a lens, thereby converting the light into an electric signal. For the image reading unit 22, it is possible to use a contact type CIS (Contact Image Sensor) and a reduced optical system CCD (Charge Coupled Device) image sensor, for example. The image reading unit 22 is provided reciprocably under the platen glasses 20 and 21 by means of a belt driving mechanism as a scanning mechanism and is reciprocated in parallel with the platen glasses 20 and 21 upon receipt of a driving force of a carriage motor.

The document cover 4 is provided with the ADF 3 for successively delivering the document from a paper feed tray 30 (a document mounting portion) to a paper discharge tray 31 (a document discharging portion) through a document delivery path 32. In a delivering process to be carried out by the ADF 3, the document passes through the reading position on the platen glass 21 and the image reading unit 22 standing by under the platen glass 21 reads the image of the document.

As shown in FIGS. 1 and 2, the document cover 4 is provided with the paper feed tray 30 and the paper discharge tray 31 in two stages, that is, upper and lower stages with the paper feed tray 30 disposed on an upper side. The document from which an image is to be read by the ADF 3 is mounted on the paper feed tray 30. A plurality of documents is mounted on the paper feed tray 30 in such a manner that leading ends in a paper feeding direction are inserted into the paper delivery path 32 in a stacking state with a first face turned upward. A rear side of the apparatus in the paper feed tray 30 is bent downward so that a protecting wall 26 is formed. A lower end of the protecting wall 26 is coupled to the upper surface of the document cover 4. By the protecting wall 26, it is possible to prevent the document mounted on the paper discharge tray 31 from dropping when the document cover 4 is opened with respect to the document mounting table 2. In a lower part on the front side of the apparatus in the paper feed tray 30, a notch 27 is formed in a part of a housing of the ADF 3. By the notch 27, it is possible to enhance a visibility from the front side of the apparatus in the document discharged to the paper discharge tray 31. In particular, a document having a small size is visually recognized by the paper feed tray 30 with difficulty. However, a space between the paper feed tray 30 and the paper discharge tray 31 is enlarged by means of the notch 27. Consequently, it is possible to particularly enhance the visibility of the document having the small size.

The paper discharge tray 31 is placed in a position separated in a vertical direction on a lower side of the paper feed tray 30, and is formed integrally with the upper surface of the document cover 4. The document from which an image is read and which is discharged from the ADF 3 is held to be loaded on the paper discharge tray 31 with the first face turned downward in a separating state from the document mounted on the paper discharge tray 30. Both side portions 28 as front and rear sides of the apparatus in the paper discharge tray 31 are slant faces inclined upward toward both sides. By the both side portions 28, it is possible to slide and pull out the document discharged to the paper discharge tray 31 along the slant faces of the both side portions 28 in order to press the document from above when it is taken out. Therefore, it is possible to easily take the document out of the paper discharge tray 31.

As shown in FIG. 2, in the ADF 3, the horizontal document delivery path 32 taking an almost U shape seen in a longitudinal section is formed in such a manner that the paper feed tray 30 and the paper discharge tray 31 are coupled to each other through the reading position on the platen glass 21. The document delivery path 32 is continuously formed as a passage having a predetermined width through which the document can pass by means of a member constituting an ADF body, a guide plate or a guide rib. Thus, the paper feed tray 30 and the paper discharge tray 31 are provided in the two stages, that is, the upper and lower stages, and the horizontal document delivery path 32 taking the almost U shape is formed as seen in the longitudinal section so as to couple them. Consequently, the width of the ADF 3 can be reduced to decrease a size.

The document delivery path 32 is extended from the paper feed tray 30 toward one end side (a left side in FIG. 2) of the document cover 4 and is subsequently curved to be inverted downward, thereby reaching the reading position on the platen glass 21, and takes an almost U shape in a horizontal direction as seen in the longitudinal section which is extended from the reading position toward the paper discharge tray 31. The document delivery path 32 is roughly divided into three parts including upper and lower portions 32A and 32C forming a straight portion in two stages, that is, upper and lower stages in the almost U shape, and a curved portion 32B curved to link the upper portion 32A and the lower portion 32C. The document delivery path 32 is used as a delivery path of a document for both a single side reading operation and a double side reading operation for the document which are to be delivered by the ADF 3.

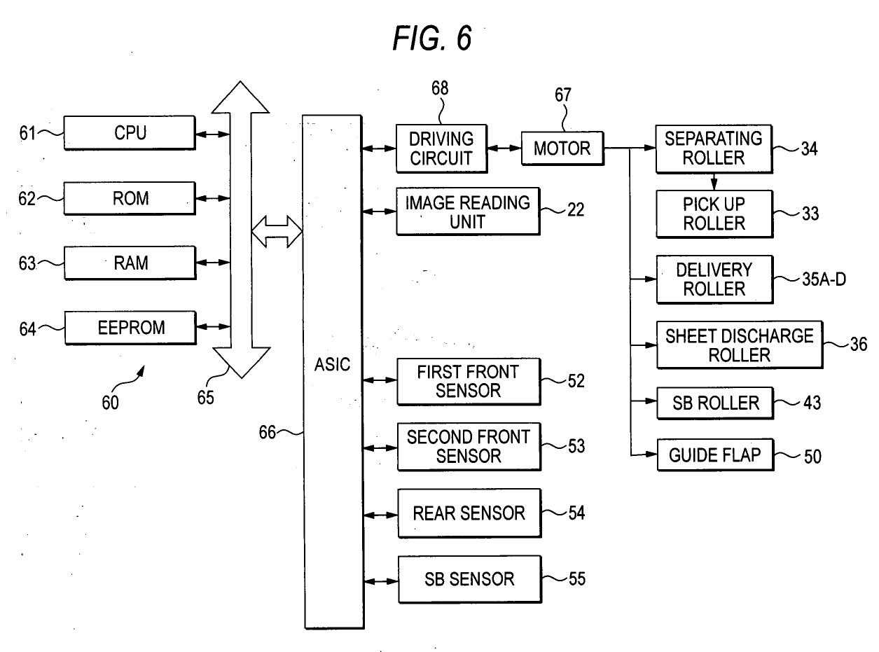

A pickup roller 33 and a separating roller 34 are provided in the vicinity of the paper feed tray 30 of the document delivery path 32. Moreover, the document delivery path 32 is provided with delivery rollers 35A, 35B, 35C and 35D, a paper discharge roller 36 and a pinch roller 37 to come in pressure contact therewith. A document delivering unit is constituted by the pickup roller 33, the separating roller 34, the delivery rollers 35A, 35B, 35C and 35D, the paper discharge roller 36 and the pinch roller 37. A driving force is transmitted from a motor 67 (see FIG. 6) as a driving source to each of the rollers constituting the document delivering unit.

As shown in the drawing, the pickup roller 33 and the separating roller 34 are provided in the vicinity of the most upstream of the document delivery path 32. The pickup roller 33 is rotatably provided in a leading portion of an arm 29 having a base end side supported pivotally on a shaft for pivotally supporting the separating roller 34. The separating roller 34 is rotatably provided in a position placed apart in a paper feeding direction from the pickup roller 33 so as to abut on an opposed surface of the document delivery path 32. The driving force is transmitted from the motor 67 to the pickup roller 33 and the separating roller 34 so that they are rotated and driven, and the driving force is also transmitted from the motor 67 to the arm 29 so that the arm 29 is moved vertically. The pickup roller 33 and the separating roller 34 have diameters which are equal to each other, and are rotated at an equal circumferential speed. A separating pad for separating the document by a friction is provided in an opposed position to the separating roller 34 in pressure contact with a roller face of the separating roller 34.

The delivery rollers 35A, 35B, 35C and 35D are provided in different positions of the document delivery path 32, respectively. In the aspect, the delivery roller 35A is provided on a directly downstream side of the separating roller 34, the delivery roller 35B is provided in the upper portion 32A of the document delivery path 32, the delivery roller 35C is provided in the lower portion 32C of the document delivery path 32 on a directly upstream side of the reading position, and the delivery roller 35D is provided in the lower portion 32C of the document delivery path 32 on a directly downstream side of the reading position. The arrangement is only illustrative and the numbers and arrangement of the delivery rollers 35A, 35B, 35C and 35D can be changed properly.

The pinch roller 37 is provided in each of the opposed positions to the delivery rollers 35A, 35B, 35C and 35D. Each pinch roller 37 has a shaft urgedelasticallybymeans of a spring and is thus caused to come in pressure contact with the roller face of each of the delivery rollers 35. When each of the delivery rollers 35A, 35B, 35C and 35D is rotated, the pinch roller 37 is also rotated together therewith. The document is caused to come in pressure contact with each of the delivery rollers 35 by each pinch roller 37 so that a rotating force of each of the delivery rollers 35A, 35B, 35C and 35D is transmitted to the document.

The paper discharge roller 36 is provided in the vicinity of the most downstream of the document delivery path 32, and the driving force is transmitted from the motor 67 so that the paper discharge roller 36 is rotated and driven in the same manner as the delivery rollers 35A, 35B, 35C and 35D. The pinch roller 37 is also provided in an opposed position to the paper discharge roller 36, and the pinch roller 37 is urged elastically by means of the spring and is thus caused to come in pressure contact with the paper discharge roller 36.

A switchback path 39 (a switchback delivery path) is coupled to a coupling position 38 in the lower portion 32C of the document delivery path 32. The switchback path 39 serves to return the document having the first face read in the reading position from the downstream side of the reading position to the document delivery path 32 on the upstream side with a leading and a trailing end inverted when the double side reading operation is to be carried out. The switchback path 39 is extended obliquely and upward from the coupling position 38 toward the upper side of the paper feed tray 30 and crosses the upper portion 32A of the document delivery path 32. The document subjected to the switchback delivery from a crossing position 40 of the upper portion 32A and the switchback path 39 is returned to the document delivery path 32. Thus, the switchback path 39 is extended from the coupling position 38 on the downstream side of the reading position toward an upper side of the paper feed tray 30 obliquely and upward. Consequently, it is not necessary to form a plurality of delivery paths in the vicinity of the curved portion 32B taking an almost U shape in a horizontal direction in the document delivery path 32. Thus, it is possible to reduce a height of the apparatus, thereby implementing a reduction in a size of the apparatus.

A terminal 41 of the switchback path 39 is opened to an external surface of the ADF 3. A document support portion 42 is formed from the terminal 41 of the switchback path 39 to the paper feed tray 30 side so as to be linked from the terminal 41. The document support portion 42 serves to support the document protruded from the terminal 41 of the switchback path 39, and constitutes an upper cover 6 of the ADF 3 at an upper side of the paper feed roller 33 and the separating roller 34. The upper cover 6 is formed to wholly cover the ADF 3 including the paper feed roller 33 and the separating roller 34 and constitutes a housing (an apparatus housing) of the ADF 3. The document support portion 42 constituted as the upper cover 6 is extended from the terminal 41 toward the paper feed tray 30 side to reach the upstream side of a paper feeding position through the paper feed roller 33 and the separating roller 34. In the double side reading operation, consequently, a part of the document entering the switchback path 39 and protruded from the terminal 41 toward the outside of the ADF 3 is supported on the document support portion 42. Therefore, the document can be prevented from being suspended at a downstream side (the left side in FIG. 2) from the paper feeding position of the document loaded onto the paper feed tray 30, and can be thus prevented from being disturbed in the paper feeding position.

A switchback roller 43 is provided on the terminal 41 side from the crossing position 40 of the switchback path 39. The driving force is transmitted from the motor 67 to the switchback roller 43 so that the switchback roller 43 is rotated and driven in both normal and reverse directions. A pinch roller 44 is provided in an opposed position to the switchback roller 43. The pinch roller 44 has a shaft urged elastically by means of a spring and is thus caused to come in pressure contact with a roller face of the switchback roller 43, and is rotated with the rotation of the switchback roller 43. The document is caused to come in pressure contact with the switchback roller 43 by means of the pinch roller 44 so that the rotating force of the switchback roller 43 is transmitted to the document. By the switchback roller 43 and the pinch roller 44, a switchback delivering unit for switchback delivering the document is implemented.

In this aspect, the switchback path 39 coupled to the coupling position 38 on the downstream side of the reading position of the document delivery path 32 is caused to cross the upper portion 32A of the document delivery path 32 and the switchback roller 43 is provided on the terminal 41 side of the crossing position 40. However, a delivery passage for the switchback path 39 may be arbitrary set. It is possible to properly change the delivery passage for the switchback path if it is coupled to a predetermined position of the document delivery path 32 and returns the document from the downstream side of the reading position to the upstream side of the reading position with the leading and the read end inverted. It is preferable, as in this aspect, that the delivery passage for the switchback path 39 is comparatively long and the terminal 41 of the switchback path 39 is coupled to the opening of the ADF housing.

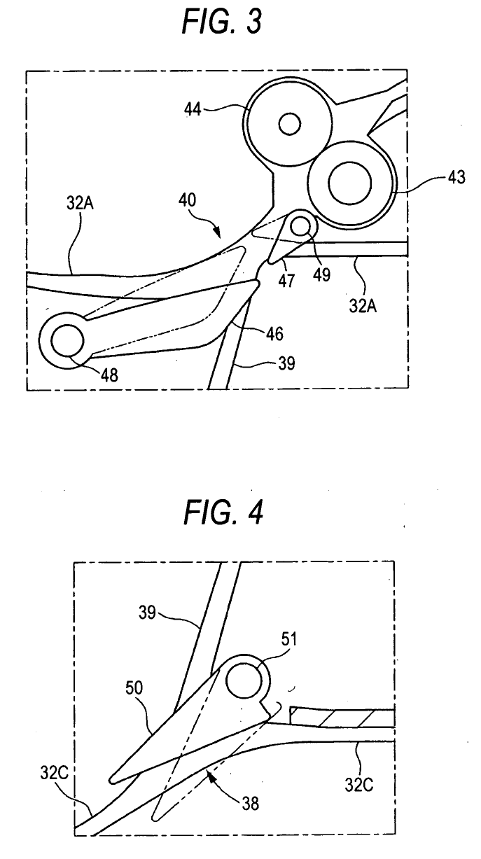

As shown in FIGS. 2 and 3, a guide flap 46 and a guide flap 47 which serve to guide the document to a desirable delivery path are provided in the crossing position 40. The guide flap 46 is provided rotatably within a predetermined range around a shaft 48 provided in a corner portion (a left and lower side in FIG. 3) on the reading position side of the document delivery path 32 and the coupling position 38 side of the switchback path 39 in the crossing position 40. The guide flap 46 is a blade-shaped plate and has a leading protruded to the crossing position 40. Although only one guide flap 46 is shown in the drawing, a plurality of guide flaps 46 taking the same shape is provided at a predetermined interval in a transverse direction of the document delivery path 32 (a perpendicular direction to the sheet of FIG. 3, a rear direction of the apparatus). The guide flaps 46 are rotated integrally.

The guide flap 46 changes a posture into a third guide posture shown in a solid line and a fourth guide posture shown in a two-dotted chain line in FIG. 3 by a rotation around the shaft 48. The guide flap 46 abuts on the document delivery path 32 or a guide member of the switchback path 39, for example, and is thus controlled to be rotated downward from the third guide posture or to be rotated upward from the fourth guide posture. The guide flap 46 takes the third guide posture so that a delivery path from the paper feed tray 30 side (a right side in FIG. 3) of the document delivery path 32 to the reading position side (a left side in FIG. 3) is provided continuously, and furthermore, a delivery path from the document delivery path 32 to the coupling position 38 side (a lower side in FIG. 3) of the switchback path 39 is closed. Consequently, the document reaching the crossing position 40 from the paper feed tray 30 side of the document delivery path 32 is permitted to enter the reading position side of the document delivery path 32 and is restricted to enter the coupling position 38 side of the switchback path 39. Moreover, the document reaching the crossing position 40 from the terminal 41 side (an upper side in FIG. 3) of the switchback path 39 is permitted to enter the reading position side of the document delivery path 32 and is restricted to enter the coupling position 38 side of the switchback path 39.

When the guide flap 46 takes the fourth guide posture, a delivery path from the coupling position 38 side of the switchback path 39 to the terminal 41 side is provided continuously, and furthermore, a delivery path from the coupling position 38 side of the switchback path 39 to the reading position side of the document delivery path 32 is closed. Consequently, the document reaching the crossing position 40 from the coupling position 38 side of the switchback path 39 is permitted to enter the terminal 41 side of the switchback path 39 and is restricted to enter the reading position side of the document delivery path 32.

The delivery path is switched by the guide flap 46 through an abutment of the document. The guide flap 46 always takes the third guide posture shown in a solid line of FIG. 3 by a dead weight thereof or upon receipt of an urging force of an elastic member such as a spring. The document delivered from the coupling position 38 toward the crossing position 40 through the switchback path 39 abuts on the guide flap 46 so that the guide flap 46 is rotated to be pushed upward in the drawing and thus takes the fourth guide posture shown in the two-dotted chain line of FIG. 3. On the other hand, the document delivered from the terminal 41 side of the switchback path 39 to the crossing position 40 abuts on the guide flap 46 and the guide flap 46 is controlled so as not to be rotated downward in the drawing from the third guide posture. For this reason, the document is guided to the guide flap 46 and enters the reading position side through the upper portion 32A of the document delivery path 32. For the shape of the blade of the guide flap 46, there is employed a shape which easily changes the posture by the abutment of the document delivered from the coupling position 38 side of the switchback path 39 to the crossing position 40 and in which the document delivered from the terminal 41 side of the switchback path 39 to the crossing position 40 is easily guided to the reading position side of the document delivery path 32. If the posture of the guide flap 46 is changed by the abutment of the document, thus, the guide flap 46 does not need to positively change the posture by the application of the driving force from the motor 67. Therefore, it is possible to implement the guide flap 46 with a simple structure.

The guide flap 47 is provided rotatably within a predetermined range around a shaft 49 provided in the corner portion (the right and upper side in FIG. 3) of the paper feed tray 30 side of the document delivery path 32 and the terminal 41 side of the switchback path 39 in the crossing position 40. The guide flap 47 is a blade-shaped plate and has a leading protruded to the crossing position 40. Although only one guide flap 47 is shown in the drawing, a plurality of guide flaps 47 taking the same shape is provided at a predetermined interval in the transverse direction of the document delivery path 32. The guide flaps 47 are rotated integrally.

The guide flap 47 changes a posture into a fifth guide posture shown in a solid line and a sixth guide posture shown in a two-dotted chain line in FIG. 3 by a rotation around the shaft 49. The guide flap 47 abuts on the document delivery path 32 or the guide member of the switchback path 39 and is thus restricted to be rotated rightward from the fifth guide posture or to be rotated upward from the sixth guide posture, for example. The guide flap 47 takes the fifth guide posture so that a delivery path from the terminal 41 side of the switchback path 39 to the reading position side of the document delivery path 32 is provided continuously, and furthermore, a delivery path from the coupling position 38 side of the switchback path 39 to the paper feed tray 30 side of the document delivery path 32 is closed. Consequently, the document reaching the crossing position 40 from the terminal 41 side of the switchback path 39 is permitted to enter the reading position side of the document delivery path 32 and is restricted to enter the paper feed tray 30 side. Moreover, the document reaching the crossing position 40 from the coupling position 38 side of the switchback path 39 is permitted to enter the terminal 41 side of the switchback path 39 and is restricted to enter the paper feed tray 30 side of the document delivery path 32.

When the guide flap 47 takes the sixth guide posture, a delivery path from the paper feed tray 30 side of the document delivery path 32 to the reading position side is provided continuously, and furthermore, a delivery path from the paper feed tray 30 side of the document delivery path 32 to the terminal 41 side of the switchback path 39 is closed. Consequently, the document reaching the crossing position 40 from the paper feed tray 30 side of the document delivery path 32 is permitted to enter the reading position side of the document delivery path 32 and is restricted to enter the terminal 41 side of the switchback path 39.

The delivery path is switched by the guide flap 47 through an abutment of the document. The guide flap 47 always takes the fifth guide posture shown in the solid line of FIG. 3 by a dead weight thereof or upon receipt of an urging force of an elastic member such as a spring. The document delivered from the paper feed tray 30 side of the document delivery path 32 abuts on the guide flap 47 so that the guide flap 47 is rotated to be pushed leftward in the drawing and thus takes the sixth guide posture shown in the two-dotted chain line of FIG. 3. On the other hand, even if the document delivered from the coupling position 38 side of the switchback path 39 to the crossing position 40 abuts on the guide flap 47, the guide flap 47 is controlled so as not to be rotated rightward in the drawing from the fifth guide posture. For this reason, the document is guided to the guide flap 47 and enters the terminal 41 side of the switchback path 39. For the shape of the blade of the guide flap 47, there is employed a shape which easily changes the posture by the abutment of the document delivered from the paper feed tray 30 side of the document delivery path 32 to the crossing position 40 and in which the document delivered from the coupling position 38 side of the switchback path 39 to the crossing position 40 is easily guided to the terminal 41 side of the switchback path 39. If the posture of the guide flap 47 is changed by the abutment of the document, thus, the guide flap 47 does not need to positively change the posture by the application of the driving force from the motor 67. Therefore, it is possible to implement the guide flap 47 with a simple structure.

As shown in FIGS. 1 and 4, a guide flap 50 is provided in the coupling position 38. The guide flap 50 is provided rotatably around a shaft 51, and the driving force is transmitted thereto from the motor 67 so that the guide flap 50 is rotated into a first guide posture shown in a solid line and a second guide posture shown in a two-dotted chain line in FIG. 4. By an abutment on the document delivery path 32 or the guide member of the switchback path 39, for example, the guide flap 50 is restricted to be rotated upward from the first guide posture or to be rotated downward from the second guide posture. In the case in which the guide flap 50 takes the first guide posture, a delivery path from the reading position side (a left side in FIG. 4) of the document delivery path 32 to the paper discharge tray 31 side (a right side in FIG. 4) is provided continuously. Consequently, the document passing through the reading position is guided from the lower portion 32C of the document delivery path 32 toward the paper discharge tray 31 through the coupling position 38. In the case in which the guide flap 50 takes the second guide posture, a delivery path from a downstream side of the reading position of the lower portion 32C of the document delivery path 32 to the switchback path 39 is provided continuously. Consequently, the document passing through the reading position is guided through the coupling position 38 to enter the switchback path 39. Thus, the guide flap 50 is provided to freely guide the document in the coupling position 38 to either the document delivery path 32 or the switchback path 39. Although only one guide flap 50 is shown in the drawing, a plurality of guide flaps 50 taking the same shape is provided at a predetermined interval in the transverse direction of the document delivery path 32. The guide flaps 50 are rotated integrally.

As shown in FIG. 2, a plurality of sensors for detecting the delivery of the document is provided in the document delivery path 32 and the switchback path 39. Specifically, the document delivery path 32 is provided with a first front sensor 52 and a second front sensor 53 on upstream and downstream sides of the separating roller 34 respectively, and a rear sensor 54 is provided on a directly upstream side of the reading position. A switchback sensor 55 is provided between the coupling position 38 of the switchback path 39 and the crossing position 40. These sensors are so-called optical sensors and have the same structure except that shapes of detectors are varied depending on a difference in a position for detection. Therefore, description will be given to the structure by taking the first front sensor 52 as an example.

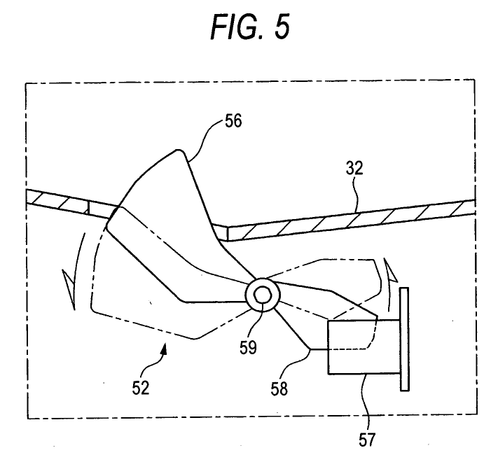

The first front sensor 52 is configured by a detector 56 protruded from a lower surface of the document delivery path 32 and rotated to retreat from the document delivery path 32 by a contact with the document, and a photointerruptor 57 for detecting the rotation of the detector 56 as shown in FIG. 5. A shielding portion 58 to be detected by the photointerruptor 57 is formed integrally with the detector 56 and is provided rotatably around a shaft 59. The detector 56 is elastically urged to a position in which the detector 56 is protruded from the document delivery path 32, that is, in a clockwise direction in the drawing by an urging device such as a spring which is not shown. In a state in which an external force is not applied to the detector 56, the detector 56 is protruded from the document delivery path 32 and the shielding portion 58 is positioned between a light emitting portion and a light receiving portion in the photointerruptor 57 as shown in a solid line in the drawing. Consequently, a light transfer of the photointerruptor 57 is blocked so that the first front sensor 52 is turned OFF.

When the document is mounted on the paper feed tray 30, it abuts on the detector 56, thereby rotating the detector 56 to retreat from the document delivery path 32. The shielding portion 58 is also rotated together with the detector 56 and thus separates from the portion between the light emitting portion and the light receiving portion in the photointerruptor 57 as shown in a two-dotted chain line in the drawing. Consequently, the light transfer of the photointerruptor 57 can be prevented from being blocked so that the first front sensor 52 is turned ON. By the ON/OFF operations of the first front sensor 52, it is detected whether the document is mounted on the paper feed tray 30 or not.

The second front sensor 53 provided on the direct downstream of the separating roller 34 serves to detect the leading or the trailing end in the document fed to the document delivery path 32 depending on the ON/OFF operations. For example, the second front sensor 53 monitors the numbers of rotations of the delivery rollers 35A, 35B, 35C and 35D after the detection of the trailing end of the document by means of an encoder or based on the number of steps of the motor 67, thereby deciding a position of the leading or the trailing end of the document in the document delivery path 32.

The rear sensor 54 provided on the direct upstream of the reading position serves to detect the leading and the trailing end of the document delivered through the document delivery path 32 depending on the ON/OFF operations. The rear sensor 54 monitors the numbers of rotations of the delivery rollers 35A, 35B, 35C and 35D after the detection of the leading or the trailing end of the document by means of an encoder or based on the number of steps of the motor 67, thereby deciding whether the leading or the trailing end of the document reaches the reading position or not. The image reading operation of the image reading unit 22 is controlled based on a signal of the rear sensor 54, and is started when the leading of the document reaches the reading position and is ended when the trailing end of the document reaches the reading position.

The switchback sensor 55 provided between the coupling position 38 of the switchback path 39 and the crossing position 40 serves to detect the leading or the trailing end of the document delivered through the switchback path 39 depending on the ON/OFF operations. For example, the switchback sensor 55 monitors the numbers of rotations of the delivery rollers 35A, 35B, 35C and 35D and the switchback roller 43 after the detection of the trailing end of the document by means of an encoder or based on the number of steps of the motor 67, thereby deciding whether the trailing end of the document passes through the crossing position 40 or not.

FIG. 6 shows a structure of a control portion 60 (control unit) of the image reading apparatus 1. The control portion 60 serves to control a whole operation of the image reading apparatus 1 in addition to the ADF 3. The control portion 60 is constituted as a microcomputer which mainly includes a CPU 61, an ROM 62, an RAM 63 and an EEPROM (Electrically Erasable and Programmable ROM) 64 as shown in the drawing, and is connected to an ASIC (Application Specific Integrated Circuit) 66 through a bus 65.

The ROM 62 stores a program for controlling various operations of the image reading apparatus 1 and the ADF 3. The RAM 63 is used as a storage region or a working region for temporarily recording various data to be used when the CPU 61 executes the program. The EEPROM 64 is a storage region for storing various sets and flags which are to be held to be recorded also after a power supply is turned OFF.

The ASIC 66 generates a relative exciting signal to be conducted to the motor 67 in accordance with a command sent from the CPU 61 and sends the same signal to a driving circuit 68 of the motor 67, and sends a driving signal to the motor 67 through the driving circuit 68, thereby controlling the rotation of the motor 67. The motor 67 serves to apply the driving force to the pickup roller 33, the separating roller 34, the delivery rollers 35A, 35B, 35C and 35D, the paper discharge roller 36, the switchback roller (SB roller) 43 and the guide flap 50 by a rotation in both normal and reverse directions at a delivery speed V1 or a reading speed V2, and is a driving source in the ADF 3.

The driving circuit 68 serves to drive the motor 67 and forms an electric signal for rotating the motor 67 upon receipt of a signal output from the ASIC 66. The motor 67 is rotated in a predetermined rotating direction at a predetermined rotating speed upon receipt of the electric signal and the rotating force of the motor 67 is transmitted to the pickup roller 33, the separating roller 34, the delivery rollers 35A, 35B, 35C and 35D, the paper discharge roller 36, the switchback roller 43 and the guide flap 50 through a driving force transmitting mechanism, respectively.

The image reading unit 22 for reading the image of the document delivered to the reading position by the ADF 3 is connected to the ASIC 66. Based on a control program stored in the ROM 62, the image reading unit 22 reads the image of the document. A driving mechanism for reciprocating the image reading unit 22 is also operated upon receipt of the signal output from the ASIC 66, which is not shown.

The first front sensor 52, the second front sensor 53, the rear sensor 54 and the switchback sensor (SB sensor) 55 are connected to the ASIC 66. The CPU 61 causes the ASIC 66 to send a predetermined output signal to operate the motor 67 and the image reading unit 22 based on the control program stored in the ROM 62 upon receipt of the ON/OFF operations of each of the sensors.

The image reading operation to be carried out by the image reading apparatus 1 will be described below.

The image reading apparatus 1 can be used as both the FBS and the ADF 3. Since the use for the FBS is not particularly related to the invention, detailed description will be omitted. In the case in which the ADF 3 is used, the document cover 4 is maintained to be closed with respect to the document mounting table 2. The opening and closing operations of the document cover 4 are detected by a sensor provided in the document mounting table 2. When the document cover 4 is closed, the ADF 3 is controlled to be usable. A document Gn to be read is mounted on the paper feed tray 30. The document Gn is mounted on the paper feed tray 30 in so-called face-up in such a manner that a face to be read (the first face) is placed on an upper side. The document Gn may be one or more. For example, in the case in which the images of the documents Gn having the same size are to be read, they are mounted on the paper feed tray 30 in such a manner that a first face of a first document G1 is turned upward, that is, in a superposing and aligning state in face-up.

When a command for starting the reading operation is input to the image reading apparatus 1, the motor 67 is driven so that the pickup roller 33, the separating roller 34, the delivery rollers 35A, 35B, 35C and 35D, the paper discharge roller 36 and the switchback roller 43 are rotated and driven in a predetermined timing. Moreover, the arm 29 is moved downward so that the pickup roller 33 comes in pressure contact with the document G1 mounted on the paper feed tray 30. Then, the documents are separated one by one from the document G1 in an uppermost position in which the rotating forces of the pickup roller 33 and the separating roller 34 are received directly and are fed into the document delivery path 32. The fed document Gn is guided into the document delivery path 32 and is thus delivered to the reading position, and the image of the document Gn is read by means of the image reading unit 22 standing by below the reading position. Thereafter, the document Gn from which the image has been read completely is discharged to the paper discharge tray 31. In such an image reading operation, a delivery path for the document Gn is varied depending on the case in which the single side reading operation for the document Gn is carried out and the case in which the double side reading operation is carried out. Whether the single side reading operation or both side reading operation for the document Gn is carried out is decided depending on a single side reading mode or a double side reading mode which is preset before the command for starting the reading operation is input.

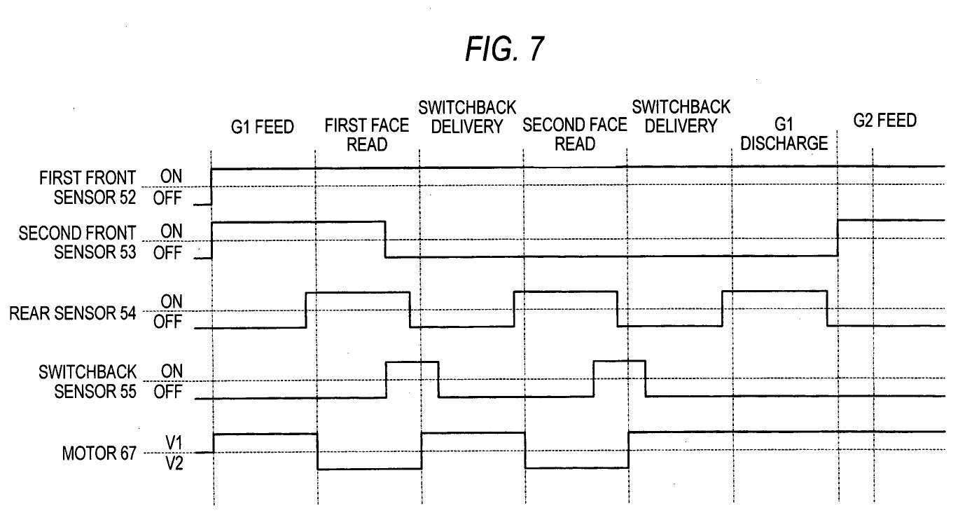

The double side readingmode will be described below. FIG. 7 is a timing chart showing the switching of the delivery speed V1 and the reading speed V2 of the motor 67 in the double side reading mode. The delivery speed V1 is a document delivery speed obtained by the ADF 3 when the operation for reading the image of the document Gn is not carried out. The reading speed V2 is a document delivery speed obtained by the ADF 3 when the operation for reading the image of the first face or the second face in the document Gn is carried out. The reading speed V2 is set corresponding to a reading resolution of the document Gn which is obtained by the image reading unit 22.

The reading resolution is set arbitrary. For example, three types of reading resolutions can be set, that is, a low resolution is set to be a “high speed”, a standard resolution is set to be a “standard” and a high resolution is set to be a “photograph”. Alternatively, numeric values indicative of reading resolutions of 100 dpi, 200 dpi, 300 dpi, 400 dip, 600 dpi and 1200 dpi may be set to be stepwise selectable. Plural types of reading speeds V2 are preset corresponding to the set reading resolutions and are stored in the ROM 62. In general, the reading speed V2 is set to be low if the reading resolution is high and is set to be high if the reading resolution is low. For the reading speed V2, it is not necessary to always set a speed having the same number as that of the reading resolutions which can be set. Accordingly, even if at least three types of reading resolutions can be set, for example, two types of reading speeds V2 may be set in some cases. According to the aspect, in the image reading apparatus 1, it is assumed that three types of reading resolutions including the “high speed”, the “standard” and the “photograph” can be set and two types of reading speeds V2 corresponding to the “high speed”, and the “standard” and “photograph” respectively are set.

The reading speed V2 corresponding to the set of the “standard” to be a standard resolution or the “photograph” to be a high resolution is lower than the reading speed V2 corresponding to the set of the “high speed” to be a low resolution. The delivery speed V1 is equal to or higher than the reading speed V2 corresponding to the low resolution. In other words, the delivery speed V1 is equal to or higher than the reading speed V2 corresponding to the set of the “high speed” to be the low resolution. The reading resolution is optionally preset before the command for starting the reading operation is input. In the case in which the reading resolution is not particularly set but the command for starting the reading operation is input, the operation for reading an image is carried out with the standard resolution. In the following description for the double side reading operation, it is assumed that the reading speed V2 corresponds to the “standard” to be the standard resolution. Accordingly, the delivery speed V1 is higher than the reading speed V2.

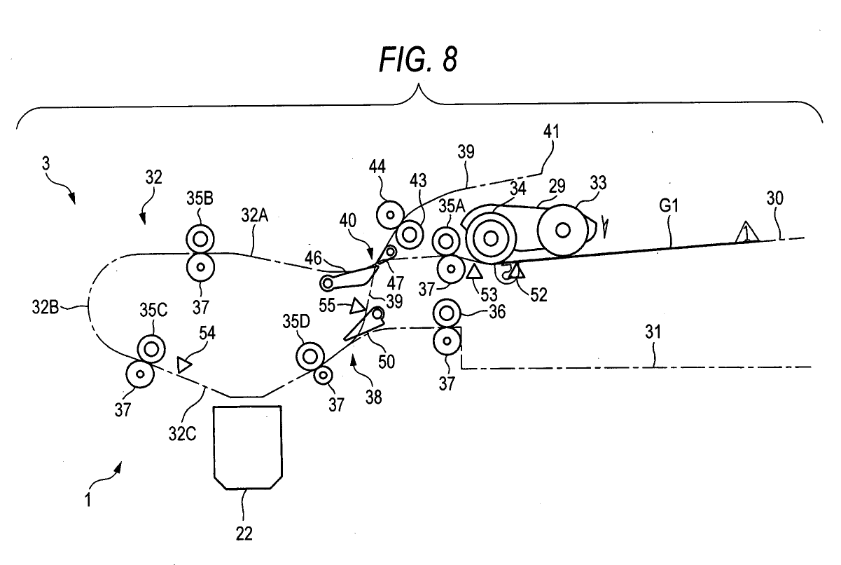

Before the document Gn is fed, the guide flap 50 is placed in a position in which the delivery path in the coupling position 38 is linked from the reading position side of the document delivery path 32 to the paper discharge tray 31 side as shown in FIG. 8. The guide flap 46 takes the third guide posture, that is, is placed in a position in which the delivery path in the crossing position 40 is provided continuously from the paper feed tray 30 side of the document delivery path 32 to the reading position side, and the guide flap 47 takes the fifth guide posture, that is, is placed in a position in which the delivery path in the crossing position 40 is provided continuously from the terminal 41 side of the switchback path 39 to the reading position side of the document delivery path 32. In the drawing, a face of the document Gn shown as “1” is a first face to be read earlier in the double side reading operation and a face shown as “2” is a second face to be read later. The first and second faces have a relationship between a surface and a back face.

When the command for starting the reading operation is input to the image reading apparatus 1, whether the document Gn is mounted on the paper feed tray 30 is detected by the first front sensor 52. The control portion 60 carries out an error display of “No document” on the display portion of the image reading apparatus 1 in the case in which it is decided that the document Gn is not mounted on the paper feed tray 30. If the document Gn is mounted on the paper feed tray 30, the motor 67 is driven at the delivery speed V1.

The control portion 60 drives the motor 67, and furthermore, moves the arm 29 downward. Consequently, the pickup roller 33 comes in pressure contact with the document G1 mounted on the paper feed tray 30. The driving force of the motor 67 at the delivery speed V1 is transmitted so that the pickup roller 33 and the separating roller 34 are rotated in a feeding direction. Consequently, the document G1 is reeled into the document delivery path 32. In some cases in which a plurality of documents Gn is mounted on the paper feed tray 30, a document G2 provided directly thereunder is also fed together with the document G1 in the uppermost position. However, the document G2 is stopped by a separating pad provided in an opposed position to the separating roller 34.

In the document delivery path 32, the driving force is transmitted from the motor 67 at the delivery speed V1 to the delivery rollers 35A, 35B, 35C and 35D and the paper discharge roller 36 so that each roller is rotated in order to deliver the document Gn from the upstream side to the downstream side in the document delivery path 32, that is, in the delivery direction. The document G1 fed from the paper feed tray 30 to the document delivery path 32 is nipped between the delivery roller 35A and the pinch roller 37 so that the rotating force is transmitted. Consequently, the document G1 is delivered to the crossing position 40 through the document delivery path 32. The document G1 is fed to the document delivery path 32 so that the second front sensor 53 is turned ON.

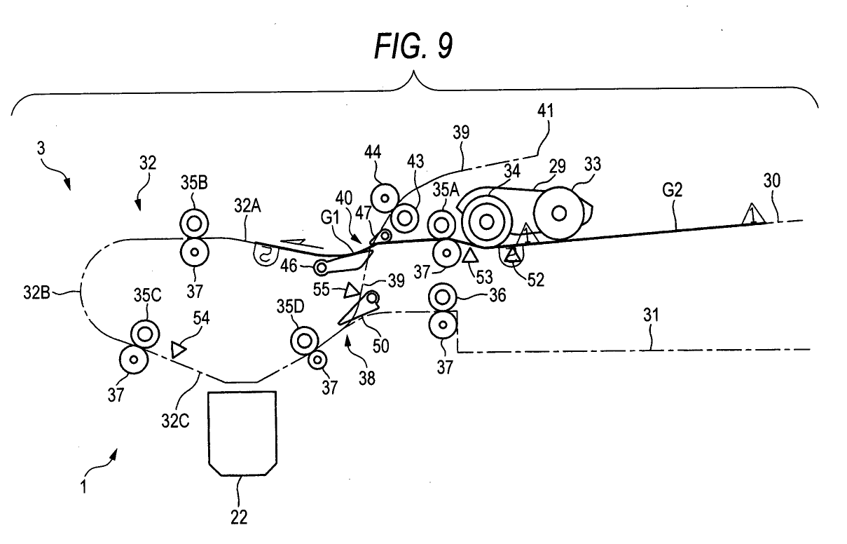

The guide flap 47 closes the delivery path from the paper feed tray 30 side of the document delivery path 32 to the crossing position 40. Therefore, the document G1 to be delivered to the crossing position 40 abuts on the guide flap 47. As shown in FIG. 9, the guide flap 47 is rotated to be pushed by the document G1 to be delivered through the document delivery path 32 and changes the posture from the fifth guide posture to the sixth guide posture. Consequently, the delivery path is provided continuously from the paper feed tray 30 side of the document delivery path 32 to the reading position side, and furthermore, the delivery path to the terminal 41 side of the switchback path 39 is closed. Moreover, the delivery path to the coupling position 38 side of the switchback path 39 is closed by the guide flap 46. Accordingly, the document G1 reaching the crossing position 40 from the paper feed tray 30 side of the document delivery path 32 is guided to the guide flap 46 and the guide flap 47 and does not advance in any direction of the switchback path 39 but is delivered to the reading position side of the document delivery path 32.

The circumferential speeds of the delivery rollers 35A, 35B, 35C and 35D and the paper discharge roller 36 are set to be higher than the circumferential speed of the separating roller 34. Therefore, the separating roller 34 runs idle by the document G1 nipped and delivered by the delivery roller 35A and the pinch roller 37 in pressure contact with the separating roller 34. Consequently, a predetermined gap is formed in the delivery direction on the first document G1 and the second document G2. The control portion 60 blocks the transmission of the driving operation to the pickup roller 33 and the separating roller 34 after the second front sensor 53 detects the trailing end in the delivery direction of the document G1 and is thus turned OFF. Consequently, the document G2 is not fed from the paper feed tray 30 to the document delivery path 32 but is held on the paper feed tray 30.

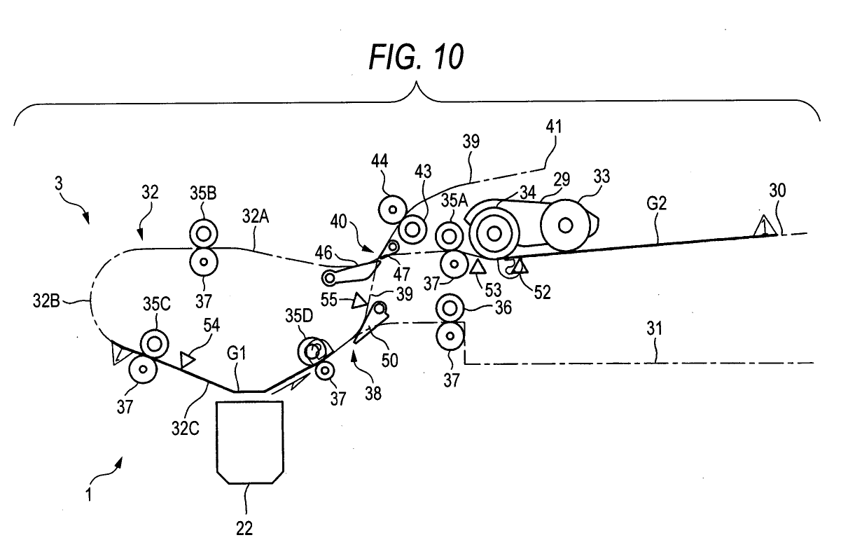

As shown in FIG. 10, the document G1 is delivered to be inverted downward by the curved portion 32B of the document delivery path 32 and the rear sensor 54 detects the leading in the delivery direction of the document G1 and is thus turned ON. The leading in the delivery direction of the document G1 is detected by the rear sensor 54 and reaches the reading position after a predetermined time passes. If the leading in the delivery direction of the document G1 reaches the reading position, therefore, the control portion 60 switches the rotating speed of the motor 67 from the delivery speed V1 to the reading speed V2. Moreover, the control portion 60 operates the image reading unit 22, thereby reading the image of the document G1. The document G1 passes through the reading position with the first face opposed to the image reading unit 22 at the reading speed V2 corresponding to the standard resolution so that an image of the first face of the document G1 is read with the standard resolution by the image reading unit 22.

The rear sensor 54 is turned OFF when detecting the trailing end in the delivery direction of the document G1. The control portion 60 switches the rotating speed of the motor 67 from the reading speed V2 to the delivery speed V1 after a predetermined time passes since the rear sensor 54 is turned OFF, and furthermore, ends the operation for reading the image of the first face in the document G1 by the image reading unit 22. Consequently, the operation for reading the image of the first face in the document G1 with the standard resolution is ended so that the document G1 is delivered at the delivery speed V1 again.

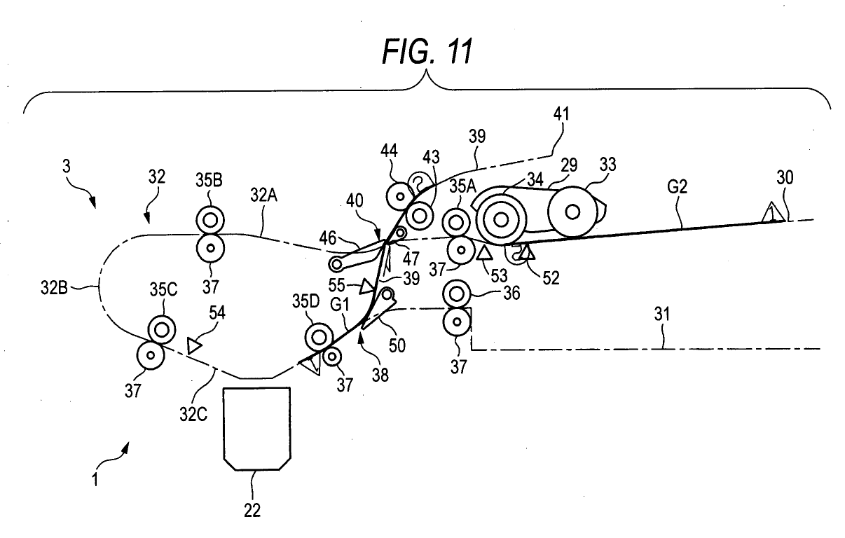

As shown in FIG. 11, the document G1 in which the first face is read with the standard resolution is guided to the guide flap 50 and is thus pulled from the document delivery path 32 into the switchback path 39 through the coupling position 38. The guide flap 50 is changed to take the second guide posture in an optional timing in which the document G1 reaches the coupling position 38. The switchback sensor 55 is turned ON when detecting the leading in the delivery direction of the document G1 entering the switchback path 39.

The guide flap 46 closes the delivery path from the switchback path 39 to the crossing position 40. Therefore, the document G1 pulled into the switchback path 39 abuts on the guide flap 46 when reaching the crossing position 40. The guide flap 46 is rotated to be pushed up by the document G1 delivered through the switchback path 39 and changes the posture from the third guide posture to the fourth guide posture as shown in FIG. 11. Consequently, the delivery path from the coupling position 38 side of the switchback path 39 to the terminal 41 side of the switchback path 39 is provided continuously, and furthermore, the delivery path to the reading position side of the document delivery path 32 is closed. Moreover, a delivery path to the paper feed tray 30 side of the document delivery path 32 is closed by the guide flap 47. Accordingly, the document G1 reaching the crossing position 40 from the coupling position 38 side of the switchback path 39 is guided to the guide flap 46 and the guide flap 47 and is further pulled into the terminal 41 side of the switchback path 39 without entering the document delivery path 32. Then, the document G1 is nipped by the switchback roller 43 and the pinch roller 44 and is delivered through the switchback path 39 toward the terminal 41 side by a rotation in a pull-in direction of the switchback roller 43.

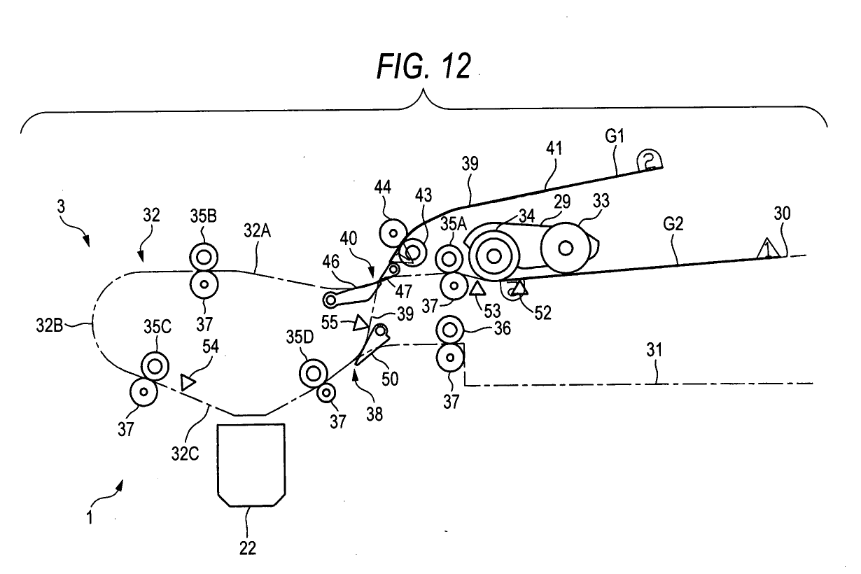

As shown in FIG. 12, the trailing end in the delivery direction of the document G1 perfectly enters the terminal 41 side beyond the crossing position 40 of the switchback path 39 and the control portion 60 then switches a rotating direction of the motor 67. The switchback sensor 55 detects the trailing end in the delivery direction of the document G1 delivered through the switchback path 39 and is then turned OFF, and thereafter, the trailing end in the delivery direction of the document G1 is delivered through the crossing position 40 after a predetermined time passes. Accordingly, the control portion 60 decides that the trailing end in the delivery direction of the document G1 perfectly enters the terminal 41 side beyond the crossing position 40 of the switchback path 39 through a detection signal of the switchback sensor 55 and the count of a delivery distance or a delivery time by means of the delivery roller 35D and the switchback roller 43. The rotating direction of the motor 67 is switched so that the document G1 nipped between the switchback roller 43 and the pinch roller 44 and protruded from the terminal 41 is returned to the crossing position 40. More specifically, the document G1 is switchback delivered to be returned to the crossing position 40 through the switchback path 39. Even if the rotating direction is switched from the pull-in direction into the returning direction, the motor 67 is driven at the delivery speed V1.

There is a possibility that a user might touch the document G1 by accident when a part of the document G1 is protruded from the terminal 41 of the switchback path 39 to the outside of the ADF 3. However, the delivery speed V1 in the inversion of the leading and the trailing end through the switchback path 39 is equal to or higher than the reading speed V2 corresponding to the standard resolution. Therefore, a time required for protruding a part of the document G1 from the ADF 3 to the outside is shorter than that in the case in which the switchback delivery is carried out at the reading speed V2. Consequently, it is possible to reduce a possibility that the user might touch the document G1 by accident in the switchback delivery. In the case in which the terminal 41 of the switchback path 39 is provided on an upper side of the paper feed tray 30 as in the ADF 3, particularly, it is possible to further remarkably obtain the effect of shorting the time required for protruding a part of the document G1 from the ADF 3 to the outside, thereby reducing the possibility that the user might touch the document by accident.

When a part of the document G1 is protruded from the terminal 41 of the switchback path 39 to the outside of the ADF 3, a portion of the document G1 which is protruded is supported by the document support portion 42. When the document G1 passes through the crossing position 40 and goes away from the guide flap 46, moreover, the guide flap 46 is rotated downward and is thus recovered to take the third guide posture.

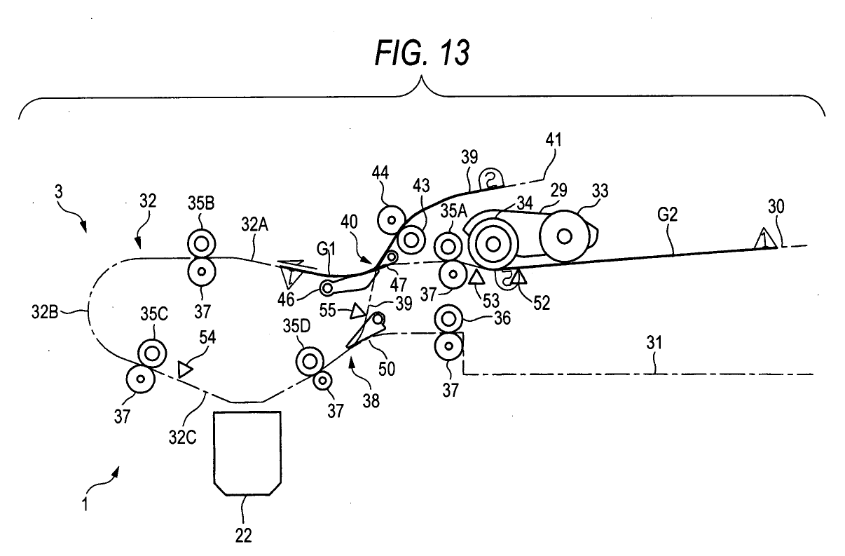

As shown in FIG. 13, the document G1 returned from the switchback path 39 abuts on the guide flap 46 taking the third guide posture in the crossing position 40. The guide flap 46 is regulated so as not to be rotated downward in the third guide posture. Accordingly, the delivery path from the terminal 41 side of the switchback path 39 to the reading position side of the document delivery path 32 is provided continuously, and furthermore, the delivery path to the coupling position 38 side of the switchback path 39 is closed. Moreover, the guide flap 47 closes the delivery path to the paper feed tray 30 side of the document delivery path 32. Therefore, the document G1 is guided to the guide flap 46 and the guide flap 47 and does not enter the coupling position 38 side of the switchback path 39 and the paper feed tray 30 side of the document delivery path 32 but is delivered from the terminal 41 side of the switchback path 39 to the reading position side of the document delivery path 32. The document G1 is returned from the switchback path 39 to the upstream side of the reading position of the document delivery path 32 so that the document G1 is first delivered through the document delivery path 32, and is then retransmitted through the document delivery path 32 in a state in which the leading and the trailing end are inverted. Thus, the document G1 is switchback delivered. Thereafter, the document G1 is delivered through the document delivery path 32 at the delivery speed V1.

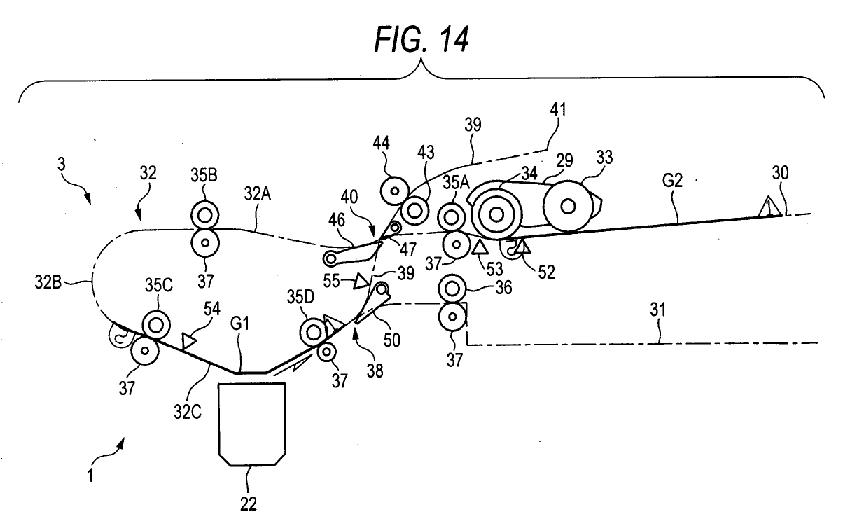

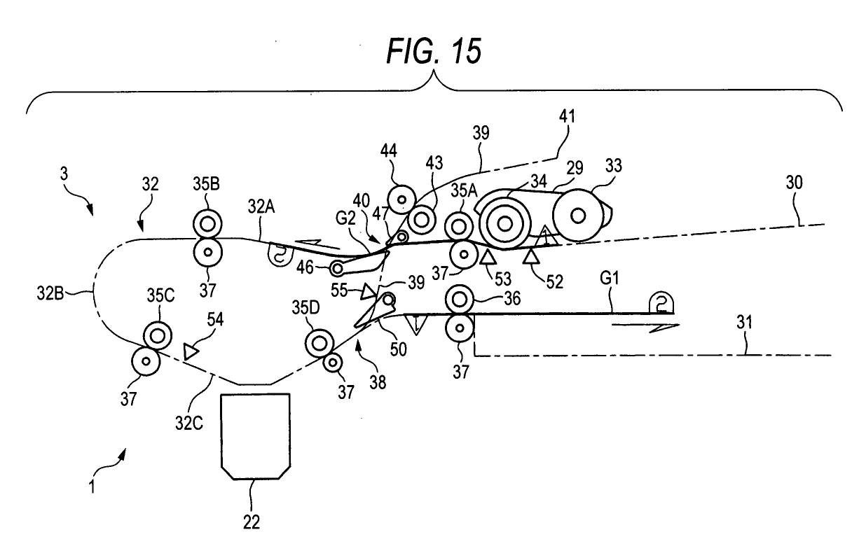

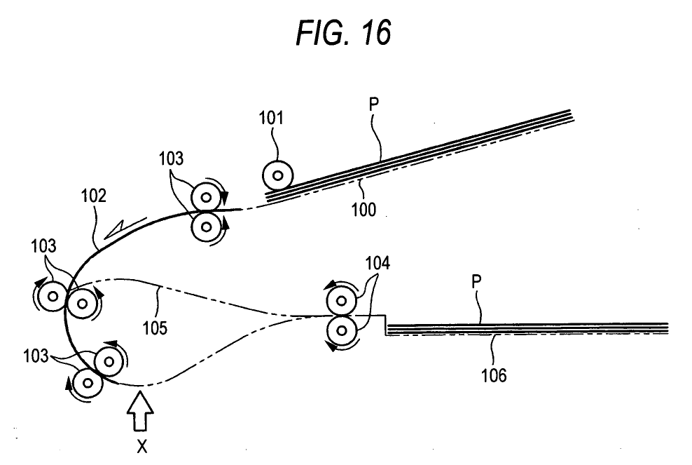

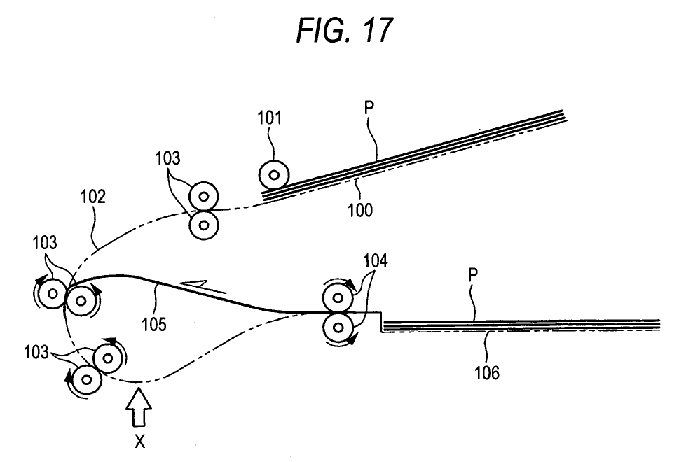

When the leading in the delivery direction of the document G1 is detected by the rear sensor 54 and reaches the reading position, the control portion 60 switches the rotating speed of the motor 67 from the delivery speed V1 to the reading speed V2, and furthermore, causes the image reading unit 22 to read the image of the second face of the document G1 as shown in FIG. 14. The document G1 passes through the reading position with the second face opposed to the image reading unit 22 at the reading speed V2 corresponding to the standard resolution and the image of the second face of the document G1 is read with the standard resolution by the image reading unit 22.

The rear sensor 54 is turned OFF when detecting the trailing end in the delivery direction of the document G1. The control portion 60 switches the rotating speed of the motor 67 from the reading speed V2 to the delivery speed V1 after a predetermined time passes since the rear sensor 54 is turned OFF, and furthermore, the operation for reading the image of the second face of the document G1 by the image reading unit 22 is ended. Consequently, the operation for reading the image of the second face of the document G1 with the standard resolution is ended and the document G1 is delivered at the delivery speed V1 again.

The document G1 having the second face read with the standard resolution is guided to the guide flap 50 and is pulled from the document delivery path 32 into the switchback path 39 through the coupling position 38. The switchback sensor 55 is turned ON when detecting the leading in the delivery direction of the document G1 pulled into the switchback path 39.

The document G1 reaching the crossing position 40 pushes the guide flap 46 upward and changes the posture from the third guide posture to the fourth guide posture, and is further pulled into the terminal 41 side of the switchback path 39 through the crossing position 40 in the same manner as in FIG. 11. In the same manner as in FIG. 12, then, the trailing end in the delivery direction of the document G1 completely enters the terminal 41 side beyond the crossing position 40 of the switchback path 39 and the control portion 60 then switches the rotating direction of the motor 67, and rotates the switchback roller 43 in a returning direction to return the document G1 to the crossing position 40. In the same manner as in FIG. 13, thereafter, the document G1 returned from the switchback path 39 is guided to the guide flap 46 and the guide flap 47 and is thus delivered at the delivery speed V1 from the terminal 41 side of the switchback path 39 to the reading position side of the document delivery path 32. Consequently, the document G1 is retransmitted through the document delivery path 32 in a state in which the leading and the trailing end are inverted again, that is, a state in which the document G1 is fed to the document delivery path 32 for the first time. Also in this case, a part of the document G1 is protruded from the terminal 41 of the switchback path 39 to the outside of the ADF 3. However, the switchback delivery is carried out at the delivery speed V1. Consequently, the time required for protruding a part of the document G1 from the ADF 3 to the outside is shorter than that in the case in which the switchback delivery is carried out at the reading speed V2. In the switchback delivery, therefore, it is possible to reduce the possibility that the user might touch the document G1 by accident.

Then, the document G1 passes through the reading position with the first face opposed thereto. In that case, the rear sensor 54 is turned ON when detecting the document G1. The delivery serves to discharge a plurality of documents Gn mounted on the paper feed tray 30 to the paper discharge tray 31 in a state in which their order is maintained. Even if the document G1 passes through the reading position, therefore, the image is not read. Accordingly, the control portion 60 exactly delivers the document G1 at the delivery speed V1 without switching the rotating speed of the motor 67.

The document G1 reaching the coupling position 38 is guided to the paper discharge tray 31 side in the coupling position 38 by means of the guide flap 50 and is discharged to the paper discharge tray 31 with the first face placed in a lower part by means of the paper discharge roller 36. The guide flap 50 is changed to take a first guide posture in an optional timing in which the document G1 reaches the coupling position 38. Consequently, the document G1 is exactly delivered at the delivery speed V1 and is thus discharged to the paper discharge tray 31 when passing through the reading position at a third time.

In the case in which a next document G2 is set onto the paper feed tray 30, the first front sensor 52 is ON. The control portion 60 transmits the driving operation from the motor 67 to the paper feed roller 33 and the separating roller 34 and rotates them when the rear sensor 55 detects the trailing end in the delivery direction of the document G1 and is thus turned OFF. Consequently, the document G2 mounted on the paper feed tray 30 is fed at the delivery speed V1 to the document delivery path 32. Thus, the discharge of the document G1 and the feed of the document G2 are carried out repetitively. Thus, it is possible to shorten a delivery time in the case in which the double side reading operation is continuously carried out over a plurality of documents Gn. The double side reading operation is carried out over the document G2 fed to the document delivery path 32 in the same manner as the document G1.

In the aspect, the double side reading operation of the image reading apparatus 1 has been described on the assumption that the documents Gn mounted on the paper feed tray 30 are discharged to the paper discharge tray 31 in a state in which their order is maintained. In the case in which it is not necessary to match the order of the documents Gn mounted on the paper feed tray 30 with that of the documents Gn discharged to the paper discharge tray 31, it is also possible to deliver the document Gn in the coupling position 38 to the paper discharge tray 31 side and to discharge the document Gn to the paper discharge tray 31 without pulling the document Gn into the switchback path 39 again after delivering the document Gn with the second face opposed to the reading position. Consequently, the order of the documents Gn is not maintained in the paper discharge tray 31. However, it is possible to omit a last switchback delivery. Therefore, it is possible to shorten a time required for reading both sides of the document Gn. Also in that case, by repetitively carrying out the discharge of the document G1 and the feed of the document G2, it is possible to shorten a time required for the delivery in the case in which both sides of each of the documents Gn are read continuously.

In the case in which the single side reading mode is set, moreover, the motor 67 is rotated at the delivery speed V1 so that the document Gn is fed from the paper feed tray 30 into the document delivery path 32. When the document Gn reaches the reading position, the rotating speed of the motor 67 is switched from the delivery speed V1 to the reading speed V2. When the document Gn passes through the reading position, then, the rotating speed of the motor 67 is switched from the reading speed V2 to the delivery speed V1 so that the document Gn is discharged to the paper discharge tray 31. In this aspect, such a single side reading mode is optional. For example, it is also possible to exactly discharge the document Gn at the reading speed V2 without switching the rotating speed of the motor 67 from the reading speed V2 to the delivery speed V1 after reading the image of the document Gn.

In the aspect, moreover, the double side reading operation has been described by taking, as an example, the case in which the resolution of the double side reading operation is the standard resolution and the delivery speed V1 is higher than the reading speed V2. For example, in the case in which the resolution of the double side reading operation is the low resolution and the delivery speed V2 is equal to the delivery speed V1, it is also possible to omit the switching of the rotating speed of the motor 67 when the document Gn reaches the reading position.

While the control portion 60 switches the rotating speed of the motor 67 so that the document delivery speeds of the document delivering unit and the switchback delivering unit are switched into the delivery speed V1 or the reading speed V2 in the aspect, the switching of the delivery speed V1 and the reading speed V2 is not restricted to the switching of the rotating speed of the motor 67 but may be implemented by switching a gear in a driving transmitting mechanism from the motor 67 to the document delivering unit and the switchback delivering unit in the invention, for example.

According to the ADF 3 provided in the image reading apparatus 1, thus, the delivery speed V1 during the operation for delivering the document Gn with the first face opposed to the reading position, and then inverting the leading and the trailing end by the switchback path 39 and delivering the document Gn with the second face opposed to the reading position is set to be equal to or higher than the reading speed V2. Therefore, it is possible to shorten the delivery time required for reading the images of both sides. In particular, there is an advantage that the delivery time from the end of the image reading operation for the first face to the start of the image reading operation for the second face can be shortened in the case in which the document Gn passing through the reading position is delivered at the reading speed V2 which is lower than the delivery speed V1 corresponding to the standard resolution or the high resolution.

Although the control portion 60 sets the delivery speed V1 to be equal to or higher than the reading speed V2 in both the case in which the first face of the document Gn passes through the reading position and the document Gn is then pulled into the switchback path 39 and the case in which the document Gn is returned from the switchback path 39 in the aspect, it may maintain the reading speed V2 even if the document Gn passes through the reading position when the document Gn is to be pulled into the terminal 41 side of the switchback path 39 and may set the delivery speed V1 to be equal to or higher than the reading speed V2 when the document Gn is to be returned from the switchback path 39.

Since the image of the first face of the document Gn is read until the trailing end in the delivery direction of the document Gn passes through the reading position even if the leading in the delivery direction of the document Gn passing through the reading position with the first face opposed thereto enters the switchback path 39 from the coupling position 38, the control portion 60 maintains the reading speed V2. In some cases in which the control portion 60 is to carry out switching into the delivery speed V1 which is equal to or higher than the reading speed V2 after the trailing end in the delivery direction of the document Gn passes through the reading position, the driving operation of the motor 67 is once stopped or the delivery of the document Gn is once stopped in order to change the gear in the driving transmitting mechanism from the motor 67 to the delivery rollers 35A to 35D and the switchback roller 43.

In consideration of a time loss and a timing control for switching from the reading speed V2 to the delivery speed V1, and a delivery distance from the reading position of the document delivery path 32 to the crossing position 40 of the switchback path 39 through the coupling position 38, the delivery of the document Gn may be switched from the reading speed V2 to the delivery speed V1 in such a timing as to switch the rotating direction of the motor 67 from the pull-in direction to the returning direction in the case in which a small time shortening effect is obtained by the switching from the reading speed V2 to the delivery speed V1 when the image of the first face of the document Gn is completely read and the document Gn is then pulled into the terminal 41 side of the switchback path 39. By simplifying the operation control of the ADF 3 which is to be carried out by the control portion 60, consequently, it is possible to obtain the same advantages as those in the aspect.

What is claimed is:

1. An auto document feeder comprising:
a document delivering unit that delivers a document along a document delivery path by which a document mounting portion and a document discharging portion are connected via a reading position;
a switchback delivering unit that returns the document from a downstream side of the reading position to an upstream side of the reading position with a leading end and a trailing end of the document inverted through a switchback delivery path coupled to a predetermined position of the document delivery path; and
a control unit that drives the document delivering unit at a reading speed corresponding to a reading resolution when delivering the document on the reading position and drives the document delivering unit and the switchback delivering unit at a delivery speed that is higher than the reading speed when delivering the document having a first face thereof opposed to the reading position and pulled into the switchback delivery path to the reading position again through the switchback delivery path.

2. The auto document feeder according to claim 1, wherein the control unit drives the document delivering unit and the switchback delivering unit at a speed higher than the reading speed when pulling the document into the switchback delivery path after the first face of the document passes on the reading position.

3. The auto document feeder according to claim 1, wherein a terminal of the switchback delivery path is opened to an external surface of the auto document feeder, and
the switchback delivering unit protrudes, from an opening to an outside of the auto document feeder, a part of the document of which the leading and the trailing ends to be inverted in the switchback delivery path.

4. The auto document feeder according to claim 3, wherein the document mounting portion and the document discharging portion are disposed in two stages, and the switchback delivery path extends toward an upper side of the document mounting portion and the document discharging portion.

5. A document feeding method comprising:
delivering a document along a document delivery path by which a document mounting portion and a document discharging portion are connected via a reading position;
delivering the document at a reading speed corresponding to a reading resolution when the document passes on the reading position
switchback delivering the document to return the document from a downstream side of the reading position to an upstream side of the reading position with a leading end and a trailing end of the document inverted through a switchback delivery path coupled to a predetermined position of the document delivery path; and
delivering the document having a first face thereof opposed to the reading position and pulled into the switchback delivery path at a delivery speed that is higher than the reading speed to the reading position again through the switchback delivery path.

6. The document feeding method according to claim 5, wherein the document is pulled into the switchback delivery path at a speed higher than the reading speed after the first face of the document passes on the reading position.

7. A computer usable medium having computer readable instructions stored thereon for enabling a computer to perform predetermined operations including the steps of:
delivering a document along a document delivery path by which a document mounting portion and a document discharging portion are connected via a reading position;
delivering the document at a reading speed corresponding to a reading resolution when the document passes on the reading position
switchback delivering the document to return the document from a downstream side of the reading position to an upstream side of the reading position with a leading end and a trailing end of the document inverted through a switchback delivery path coupled to a predetermined position of the document delivery path; and
delivering the document having a first face thereof opposed to the reading position and pulled into the switchback delivery path at a delivery speed that is higher than the reading speed to the reading position again through the switchback delivery path.
